(19) United States
(12) Patent Application Publication
(10) Pub. No.: US 2009/0285005 A1
(43) Pub. Date: Nov. 19, 2009

(54) SPACE-SAVING INVERTER WITH REDUCED SWITCHING LOSSES AND INCREASED LIFE

(75) Inventor: Kurt Göpfrich, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/296,332

(22) PCT Filed: Mar. 15, 2007
(86) PCT No.: PCT/EP07/52451

§ 371 Date: Oct. 7, 2008

(30) Foreign Application Priority Data
Apr. 7, 2006 (DE) 102006016502.0

(51) Int. Cl. H02M 7/5387

(52) U.S. Cl. 363/132

(57) ABSTRACT

The invention relates to an inverter, and in particular a solar inverter. According to the invention, the inverter has a step-up converter (4), a mains-commutated controlled converter (2) and a filter (6), with the filter (6) being linked on the output side to the AC-side connections 10 (12, 14, 16), and with the step-up converter (4) being linked on the output side to the DC-side connections (8, 10) of the mains-commutated controlled converter (2) with a power semiconductor switch (28) which can be turned off being provided, together with a back-to-back parallel-connected diode (30) in each case as converter valves (T1, T2; T3, T4; T5, T6) for each phase (R, S, T) of the mains-commutated controlled converter (2), and with the controlled side of these power semiconductor switches (28) which can be turned off being linked to a control device (32) to whose inputs phase voltages that have been determined from a power supply system (18) are applied. This results in an inverter, in particular a solar inverter, which costs less and saves more space.

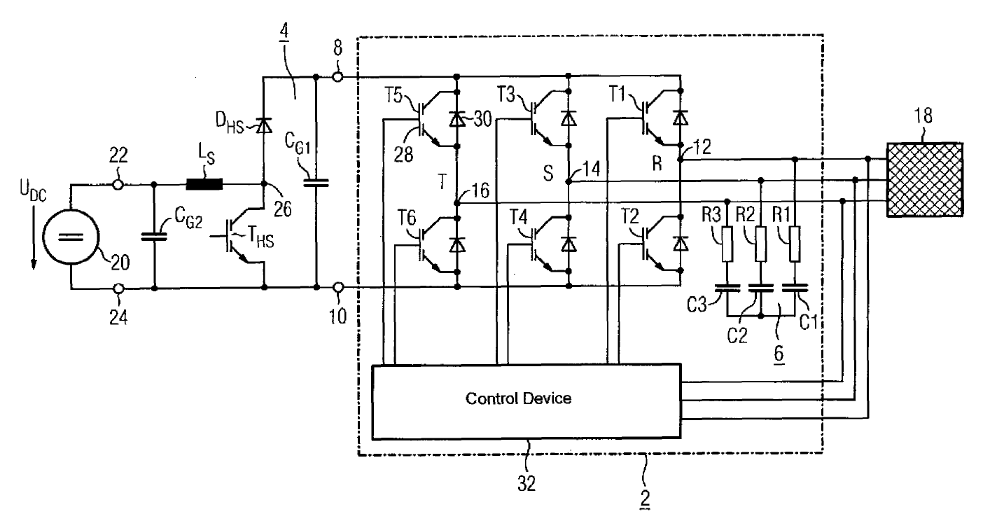

The invention relates to an inverter, in particular a solar inverter.

In the case of many regenerative energy sources, energy is intended to be fed from a DC voltage source into a power supply system, in particular a three-phase power supply system. An inverter is required for this purpose, with the aid of which inverter a direct current can be converted into an alternating current. If a solar generator is used as the regenerative energy source, the inverter with which the energy produced by means of the solar generator is intended to be fed into a power supply system is designated and marketed as a solar inverter.

Commercially available solar inverters have a self-commutated pulse-controlled power converter, which is linked on the AC voltage side to a power supply system consuming the regenerative energy by means of a polyphase inductor circuit. On the DC voltage side, at least one electrolyte capacitor is connected electrically in parallel with this self-commutated pulse-controlled power converter. The control device of this self-commutated pulse-controlled power converter is electrically conductively connected on the control side in each case to a control input of the disconnectable power semiconductor switches of the self-commutated pulse-controlled power converter, with determined phase voltages and phase currents of the energy-consuming power supply system being present on the input side.

The use of an electrolyte capacitor in such a commercially available solar inverter limits the life of this solar inverter. This life is only a few 10,000 operating hours long. In addition, this solar inverter requires power supply system inductors, which take up a not negligible amount of space. In addition, the control device is complex and therefore cost-intensive.

Such commercially available solar inverters are constructed, for example, with an inverter of an uninterruptible power supply device, which is also referred to as a UPS device. As a result, costs are saved for the development of a solar inverter. Such a second use of an inverter of a UPS device is an option since, firstly, the inverter of the UPS device likewise feeds energy from a battery into a power supply system and, secondly, the UPS device comprises individual components such as a rectifier, a voltage intermediate circuit and an inverter. As a result, the “inverter” component of a UPS device is available.

The invention is now based on the object of specifying an inverter with which a solar inverter becomes more cost-effective and space-saving.

This object is achieved according to the invention by the features of claim 1.

By virtue of the fact that the inverter has a line-commutated, controlled power converter, which is provided on the DC voltage side with a step-up converter and on the AC voltage side with a filter, this inverter no longer has any electrolyte capacitors or power supply system inductors. This increases the life of the inverter considerably and substantially reduces its space requirement. Since a line-commutated, controlled power converter is used instead of a self-commutated pulse-controlled power converter, the complex control device is replaced by a simple control device. This simple control device now only requires the phase voltages of the energy-consuming power supply system.

A line-commutated, controlled power converter is known from the publication “Fundamental Frequency Front End Converter (F³E)—a DC-link drive converter without electrolytic capacitor”, printed in the conference volume of the “PCIM 2003” conference in Nuremberg, May 2003.

The invention now consists in the fact that the load-side, self-commutated pulse-controlled power converter is replaced by a step-up converter, in particular a high-frequency-clocked step-up converter, for the construction of a solar inverter of this capacitorless voltage intermediate circuit converter. A solar generator can then be connected to the two input terminals of this step-up converter. By means of this step-up converter, this inverter can be controlled in such a way that the solar generator is always at the Maximum Power Point (MPP) operating point.

In an advantageous embodiment of the inverter according to the invention, the step-up converter is provided on the input side with a capacitor. By means of this capacitor, voltage fluctuations of a solar generator are averaged over a predetermined period of time.

As is known from text books, the step-up converter has a disconnectable power semiconductor switch, a decoupling diode, a storage inductor and a smoothing capacitor, which are connected to one another in a known manner so as to form a step-up converter. In order that the physical size of the storage inductor is as small as possible, this step-up converter is clocked at a high frequency. The higher the clock frequency, the smaller the physical size of the storage inductor. As the clock frequency increases, the switching losses of the disconnectable power semiconductor switch also increase. In order to reduce these switching losses, a disconnectable power semiconductor switch consisting of silicon carbide is provided as disconnectable power semiconductor switch. A normally off MOS field effect transistor (MOSFET) or an insulated gate bipolar transistor (IGBT) consisting of silicon with a diode consisting of silicon carbide connected back-to-back in parallel is used, for example, as disconnectable power semiconductor switch. As a result of the reduction in the switching losses, the disconnectable power semiconductor switch of the step-up converter now only requires a cooling device, which barely takes up any notable amount of space, with the result that the inverter according to the invention takes up considerably less space than a known inverter.

In order to explain the invention further, reference is made to the drawing, in which an embodiment of an inverter according to the invention is illustrated schematically.

In accordance with the equivalent circuit diagram in this FIGURE, the inverter according to the invention, in particular a solar inverter, has a line-commutated, controlled power converter 2 with a filter 6 on the AC voltage side and a step-up converter 4 on the DC voltage side. This step-up converter 4 is linked on the output side to terminals 8 and 10, on the DC voltage side, of the line-commutated, controlled power converter 2. The filter 6 is electrically conductively connected to the terminals 12, 14 and 16, on the AC voltage side, of the line-commutated, controlled power converter 2. A power supply system 18, which is intended to consume energy from a DC voltage source 20, for example a regenerative energy source, is likewise connected to these terminals 12, 14 and 16.

The step-up converter 4, which electrically conductively connects, on the DC voltage side, the line-commutated, controlled power converter 2 to the terminals 22 and 24, on the DC voltage side, of the inverter, to which terminals a DC voltage source 20 is to be connected, has a disconnectable power semiconductor switch T_{HS}, a decoupling diode D_{HS}, a storage inductor L_{S} and a smoothing capacitor C_{G1}. The disconnectable power semiconductor switch T_{HS} and the decoupling diode D_{HS} are connected electrically in series. The smoothing capacitor C_{G1} is connected electrically in parallel with this series circuit. As a result, this smoothing capacitor C_{G1} is likewise connected electrically in parallel with the terminals 8 and 10, on the DC voltage side, of the line-commutated, controlled power converter 2. The node 26 in the series circuit comprising the disconnectable power semiconductor switch T_{HS} and the decoupling diode D_{HS} is electrically conductively connected to the terminal 22, on the DC voltage side, of the inverter by means of the storage inductor L_{S}. If a solar generator is used as DC voltage source 20, the DC voltage U_{DC} supplied fluctuates over a predetermined period of time (course of the day). In order to approximately smooth these voltage fluctuations, a second smoothing capacitor C_{G2} is connected electrically in parallel with the terminals 22 and 24, on the DC voltage side, of the inverter.

The line-commutated, controlled power converter 2 has, as power converter valves T1, . . . , T6, in each case one disconnectable power semiconductor switch 28, in particular an insulated gate bipolar transistor (IGBT), with which in each case one diode 30 is connected electrically back-to-back in parallel. In each case two power converter valves T1, T2 or T3, T4 or T5, T6 form a bridge branch, which is also referred to as power converter phase R or S or T. In each case one node between two power converter valves T1, T2 or T3, T4 or T5, T6, which are connected electrically in series, of a power converter phase R or S or T forms a terminal 12 or 14 or 16, on the AC voltage side, of the line-commutated, controlled power converter 2. Firstly the filter 6 and secondly the energy-consuming power supply system 18 are connected to these terminals 12, 14 and 16.

The filter 6 has three capacitors C1, C2 and C3, which in this case are electrically star-connected. However, they may also be electrically delta-connected. This filter 6 also has three damping resistors R1, R2 and R3, which are each connected electrically in series with a capacitor C1 and C2 and C3, respectively.

In order to drive the disconnectable power semiconductor switches 28 of the power converter valves T1, . . . , T6 of the line-commutated, controlled power converter 2, a control device 32 is provided. This control device 32 produces control signals, which drive the disconnectable power semiconductor switches 28 of the power converter valves T1, . . . , T6 in such a way that they are each on when in each case the corresponding diode 30, connected back-to-back in parallel, is on. This means that, in each case at the natural commutation times (point of intersection between two phase voltages; amplitude of a phase-to-phase system voltage is equal to zero), a drive signal is generated. Thus, each disconnectable power semiconductor switch 28 of the line-commutated, controlled power converter 2 is switched on during the current-conducting times of its diodes 30, which are connected electrically back-to-back in parallel. As a result of this system-frequency control of the disconnectable power semiconductor switches 28 of the power converter valves T1, . . . , T6 of the line-commutated, controlled power converter 2, said power converter 2 is regenerative at any time. One embodiment of the control device 32 is described, for example, from DE 199 13 634 A1.

This line-commutated, controlled power converter and the filter 6 together form a so-called fundamental frequency front end (F³E). A capacitorless voltage intermediate circuit converter, which has an F³E power converter as the systems-side power converter in addition to a load-side, self-commutated pulse-controlled power converter, is described in detail, as mentioned at the outset, in the conference volume of the “PCIM 2003” technical conference.

In order that the storage inductor L_{S} of the step-up converter 4 takes up as small a physical volume as possible, in order that it can be integrated in the inverter, in particular solar inverter, with a small space requirement, the disconnectable power semiconductor switch THS of the step-up converter 4 is clocked at a high frequency. In order to be able to convert a high clock frequency, a MOSFET or a junction field effect transistor (JFET) is provided. In the equivalent circuit diagram of the inverter in accordance with the invention illustrated, an n-channel enhancement MOSFET is provided as disconnectable power semiconductor switch T_{HS}. In order that the switching losses remain low given a high clock frequency, a MOSFET and a JFET consisting of silicon carbide are used as disconnectable power semiconductor switch T_{HS}. In addition, an IGBT can be used as disconnectable power semiconductor switch T_{HS}. In order that the latter can convert a high clock frequency, the IGBT consists of silicon and an associated diode, connected back-to-back in parallel, consists of silicon carbide. By means of this step-up converter 4, a DC voltage at the smoothing capacitor C_{G1} can be controlled to the value of a rectified system voltage. As a result, a solar generator, which is connected as DC voltage source 20 to the terminals 22 and 24, on the DC voltage side, of the inverter, in particular a solar inverter, is always operated at the MPP operating point.

As a result of this configuration of an inverter, in particular a solar inverter, according to the invention, firstly the life of this inverter is substantially extended and secondly this inverter can be produced significantly more cost-effectively than a commercially available inverter. In addition, this inverter in accordance with the invention requires significantly less space.

1.-10. (canceled)

11. An inverter comprising:
a line-commutated, controlled power converter having a DC voltage side and an AC voltage side and power converter valves associated with each AC voltage phase, with each power converter valve comprising a disconnectable power semiconductor switch and a reverse-biased diode connected in parallel with the disconnectable power semiconductor switch,
a step-up converter having an output connected to terminals on the DC voltage side, and
a filter connected to terminals on the AC voltage side, and
a control device having an output connected to control inputs of the disconnectable power semiconductor switches and an input receiving measured phase voltages of a power mains.

12. The inverter of claim 11, wherein the step-up converter comprises a capacitor connected across the DC input terminal of the inverter.

13. The inverter of claim 11, wherein the step-up converter comprises:
a disconnectable power semiconductor switch,
a decoupling diode connected in series with the disconnectable power semiconductor switch at a connection point,
a smoothing capacitor connected in parallel with the series-connection of the decoupling diode and the disconnectable power semiconductor switch,
a smoothing choke connected between the connection point and a DC input terminal of the inverter.

14. The inverter of claim 13, wherein the disconnectable power semiconductor switch of the step-up converter comprises a self-blocking MOS field effect transistor.

15. The inverter of claim 13, wherein the disconnectable power semiconductor switch of the step-up converter comprises an insulated gate bipolar transistor made of silicon connected in parallel with a reverse-biased diode made of silicon carbide.

16. The inverter of claim 14, wherein the self-blocking MOS field effect transistor is made of silicon carbide.

17. The inverter of claim 11, wherein the filter on the AC voltage side comprises three capacitors connected in a star-configuration.

18. The inverter of claim 11, wherein the filter on the AC voltage side comprises three capacitors connected in a Delta-configuration.

19. The inverter of claim 17, wherein the filter on the AC voltage side further comprises damping resistors connected in series with each capacitor in one-to-one correspondence.

20. The inverter of claim 18, wherein the filter on the AC voltage side further comprises damping resistors connected in series with each capacitor in one-to-one correspondence.

21. The inverter of claim 12, wherein the smoothing capacitor is implemented as a film capacitor.
